(19) United States
(12) Patent Application Publication
(10) Pub. No.: US 2024/0256853 A1
(43) Pub. Date: Aug. 1, 2024

(54) SYSTEM AND METHOD FOR MANAGING LATENT BIAS IN CLUSTERING BASED INFERENCE MODELS

(71) Applicant: Dell Products L.P., Round Rock, TX (US)

(72) Inventors: OFIR EZRIELEV, Be'er Sheva (IL); TOMER KUSHNIR, Omer (IL); FATEMEH AZMANDIAN, Raynham, MA (US)

(21) Appl. No.: 18/160,577

(22) Filed: Jan. 27, 2023

(51) Int. Cl. G06N 3/08

(52) U.S. Cl. CPC G06N 3/08

(57) ABSTRACT

Methods, systems, and devices for providing computer-implemented services are disclosed. To provide the computer-implemented services, inference models used by data processing systems may be managed to reduce latent bias. The inference models may be managed by establishing supervised models based on the results of unsupervised learning. The supervised models may then be subjected to training to reduce the levels of latent bias, and analysis to identify features contributing to the latent bias. The supervised learning may then be performed without consideration for the identified features.

### FIELD

Embodiments disclosed herein relate generally to managing inference models. More particularly, embodiments disclosed herein relate to systems and methods to manage latent bias in inference models.

### BACKGROUND

Computing devices may provide computer-implemented services. The computer-implemented services may be used by users of the computing devices and/or devices operably connected to the computing devices. The computer-implemented services may be performed with hardware components such as processors, memory modules, storage devices, and communication devices. The operation of these components may impact the performance of the computer-implemented services.

### BRIEF DESCRIPTION OF THE DRAWINGS

Embodiments disclosed herein are illustrated by way of example and not limitation in the figures of the accompanying drawings in which like references indicate similar elements.

FIG. 1 shows a block diagram illustrating a system in accordance with an embodiment.

FIG. 2A shows a diagram illustrating a neural network in accordance with an embodiment.

FIG. 2B-2C show diagrams illustrating a multipath neural network in accordance with an embodiment.

FIGS. 3A-3C show flow diagrams illustrating methods for managing inference models in accordance with an embodiment.

FIG. 3D shows a flow diagram illustrating a method for identifying input features contributing to latent bias exhibited by the inference model in accordance with an embodiment.

FIGS. 4A-4C show diagrams illustrating data structures and interactions during management of an inference model in accordance with an embodiment.

FIG. 5 shows a diagram illustrating a method for reducing latent bias in unsupervised learning in accordance with an embodiment.

FIGS. 6A-6E show clustering diagrams illustrating processes for reducing levels of latent bias in accordance with an embodiment.

FIG. 7 shows a block diagram illustrating a data processing system in accordance with an embodiment.

### DETAILED DESCRIPTION

Various embodiments will be described with reference to details discussed below, and the accompanying drawings will illustrate the various embodiments. The following description and drawings are illustrative and are not to be construed as limiting. Numerous specific details are described to provide a thorough understanding of various embodiments. However, in certain instances, well-known or conventional details are not described in order to provide a concise discussion of embodiments disclosed herein.

Reference in the specification to “one embodiment” or “an embodiment” means that a particular feature, structure, or characteristic described in conjunction with the embodiment can be included in at least one embodiment. The appearances of the phrases “in one embodiment” and “an embodiment” in various places in the specification do not necessarily all refer to the same embodiment.

In general, embodiments disclosed herein relate to methods and systems for providing computer-implemented services. The computer-implemented services may be provided using inferences obtained from inference models.

The quality of the computer-implemented services may depend on the quality of the inferences provided by the inference models. The quality of the inferences provided by the inference models may depend on whether the inference model exhibit latent bias.

To reduce latent bias, a training procedure may be implemented that facilitates both training for predictive power with respect to labels and untraining for predictive power with respect to bias features. By performing the combined training and untraining, trained inference models may be less likely to exhibit latent bias or may exhibit latent bias to reduced degrees.

To reduce latent bias in unsupervised learning, the classifications provided through unsupervised learning may be used to establish a training data set. The training data set may be used to perform supervised learning (e.g., with the classifications used as labels) to obtain a trained model. The training procedure to reduce latent bias may then be used to further train the trained model to attempt to reduce latent bias in the model to obtain an updated model.

Once obtained, the updated model may be analyzed to identify features used in the construction of the model that had outsized contributions to latent bias when compared to contributions to label prediction.

The identified features may then be removed from consideration for unsupervised learning, and the original data set may be reclassified to obtain a final set of classifications. In the context of, for example, clustering, the final set of classifications may be cluster assignments for records of the original data set.

By doing so, embodiments disclosed herein may provide for training of inference models that meet a variety of goals. Accordingly, desirable inference that exhibit reduced levels of latent bias may be used to provide computer implemented services.

In an embodiment, a method for managing an inference model is provided. The method may include clustering a data set into first clusters to obtain first cluster assignments for records of the data set; training a multiheaded inference model using the records and the first cluster assignments; performing modified split training of the multiheaded inference model to obtain an updated multiheaded inference model; obtaining an updated data set using the updated multiheaded inference model by removing at least one feature from the data set based on a predictive power level of the multiheaded inference model with respect to the first cluster assignments and a predictive power level for bias features; clustering the updated data set into second clusters to obtain second cluster assignments for records of the updated data set; and providing computer implemented services using the second cluster assignments.

The multiheaded inference model may include a shared body; a feature head that generates first inferences for the first cluster assignments; and a bias feature head that generates second inferences for bias features.

Performing the modified split training may include modifying weights of the feature head to increase a predictive power level of the first inferences; and modifying weights of the bias feature head to decrease a predictive power level of the second inferences.

The modified split training may be performed using a training data set that associates features of the data set with the first cluster assignments and the bias features.

Obtaining the updated data set may include, for each feature of the data set: identifying a first level of contribution of the feature to the predictive power level of the first inferences; identifying a second level of contribution of the feature to the predictive power level of the second inferences; ranking the feature among the features of the of data set based on the first level of contribution and the second level of contribution to identify a worst ranked feature; and using the worst ranked feature as the at least one feature.

The features may be ranked based on a difference between the first level of contribution and the second level of contribution, and the worst ranked feature having a lowest difference of the differences associated with the features.

The updated data set may include less data than the data set.

In an embodiment, a non-transitory media is provided that may include instructions that when executed by a processor cause the computer-implemented method to be performed.

In an embodiment, a data processing system is provided that may include the non-transitory media and a processor and may perform the computer-implemented method when the computer instructions are executed by the processor.

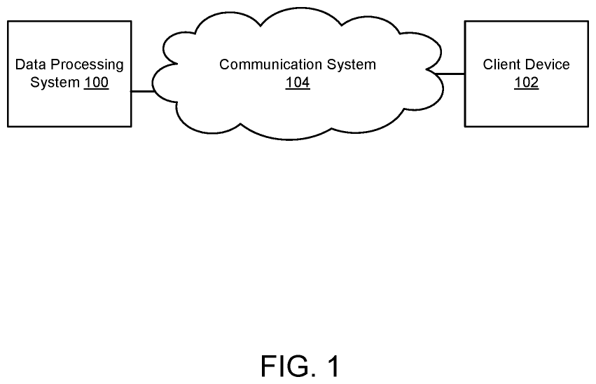

Turning to FIG. 1, a block diagram illustrating a system in accordance with an embodiment is shown. The system shown in FIG. 1 may provide computer-implemented services. The computer-implemented services may include, for example, database services, instant messaging services, and/or other types of computer-implemented services. The computer-implemented services may be provided by any number of data processing systems (e.g., 100). The data processing systems may provide similar and/or different computer-implemented services. The data processing systems, client device 102, and/or other devices (not shown) may utilize the computer-implemented services.

During their operation, any of the computer-implemented services may consume inferences. For example, the inferences may indicate content to be displayed as part of the computer-implemented services, how to perform certain actions, and/or may include other types of information used by the computer-implemented services during their performance.

To obtain the inferences, one or more inference models (e.g., hosted by data processing systems and/or other devices operably connected to the data processing systems) may be used. The inference models may, for example, ingest input and output inferences based on the ingested input. The content of the ingest input and output may depend on the goal of the respective inference model, the architecture of the inference model, and/or other factors.

However, if the inferences generated by the inference models do not meet expectations of the consumers (e.g., the computer-implemented services) of the inferences, then the computer-implemented services may be provided in an undesired manner. For example, the computer-implemented services may presume that the inferences generated by the inference models are of a certain degree of accuracy. If the inferences fail to meet this degree of accuracy, then the computer-implemented services may be negatively impacted.

The inferences generated by an inference model may, for example, be inaccurate if the inference models do not make inferences based on input as expected by the manager of the inference model. As noted above, to obtain inferences, the inference model may ingest input and provide output. The relationship between ingested input and output used by the inference model may be established based on training data. The training data may include known relationships between input and output. The inference model may attempt to generalize the known relationships between the input and the output.

However, the process of generalization (e.g., training processes) may result in unforeseen outcomes. For example, the generalization process may result in latent bias being introduced into the generalized relationship used by the inference model to provide inferences based on ingest input data. Latent bias may be an undesired property of a trained inference model that results in the inference model generating undesirable inferences (e.g., inferences not made as expected by the manager of the inference model). For example, training data may include a correlation that is not obvious but that may result in latent bias being introduced into inference model trained using training data. If consumed by computer-implemented services, these inaccurate or otherwise undesirable inferences may negatively impact the computer-implemented services.

Latent bias may be introduced into inference models based on training data limits and/or other factors. These limits and/or other factors may be based on non-obvious correlations existing in the training data. For example, data processing system 100 may have access to a biased source of data (e.g., a biased person) in which the training data is obtained from. The biased person may be a loan officer working at a financial institution, and the loan officer may have authority to view personal information of clients of the financial institution to determine loan amounts for each of the clients. Assume the loan officer carries discriminatory views against those of a particular ethnicity. The loan officer may make offers of low loan amounts to clients that are of the particular ethnicity, in comparison to clients that are not of the particular ethnicity. When training data is obtained from a biased source, such as the loan officer, the training data may include correlations that exist due to the discriminatory views of the loan officer. This training data may be used when placing an inference model of data processing system 100 in a trained state in order to provide inferences used in the computer-implemented services.

Due to these limits and/or other factors, such as biased sources, the training data used to train the inference model may include information that correlates with a bias feature, such as sex (e.g., male and/or female), that is undesired from the perspective of consumers of inferences generated by the inference model. This correlation may be due to the features (input data) used as training data (e.g., income, favorite shopping locations, number of dependents, etc.).

For example, a trained inference model that includes latent bias, when trained to provide inferences used in computer implemented services (to determine a risk an individual has of defaulting on loans) provided by a financial institution, may consistently generate inferences indicating female persons have a high risk of defaulting on loans. This inadvertent bias (i.e., latent bias) may cause undesired discrimination against female persons and/or other undesired outcomes by consumption of the inferences by the financial institution.

In general, embodiments disclosed herein may provide methods, systems, and/or devices for providing inference model management services in a manner that reduces the likelihood of an inference model making inferences (predictions) indicative of a bias feature. Consequently, computer-implemented services that consume the inferences may also be more likely to be provided in a manner consistent with a goal of the computer-implemented services.

To provide the inference model management services, a system in accordance with an embodiment may manage an inference model by executing a modified split training method. By doing so, the provided inference model management services may be more capable of removing, at least in part, latent bias from inference models when the inference models' predictions are indicative of a bias feature.

Before execution of the modified split training, an inference model may be identified as making predictions (i.e., inferences) that are indicative of a bias feature. The inference model may be analyzed using any method to identify presence of the bias feature.

To perform the modified split training, the inference model may be divided to obtain a multipath inference model. The multipath inference model may include two or more inference generations paths, but for simplicity of discussion, embodiments herein illustrate and are discussed with respect to a multipath inference model with two inference generation paths.

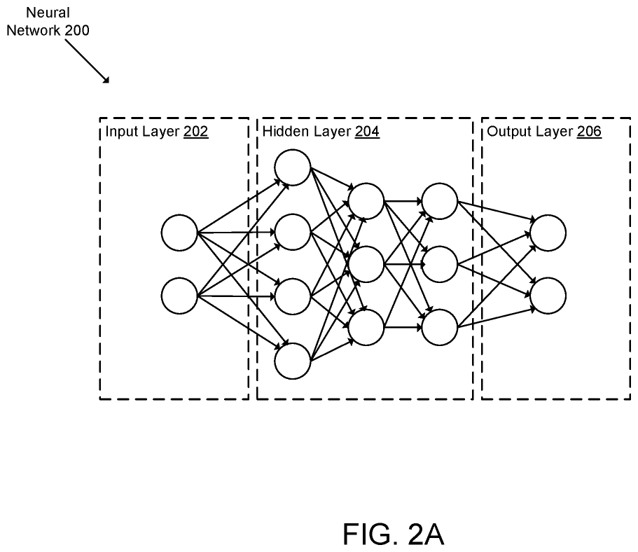

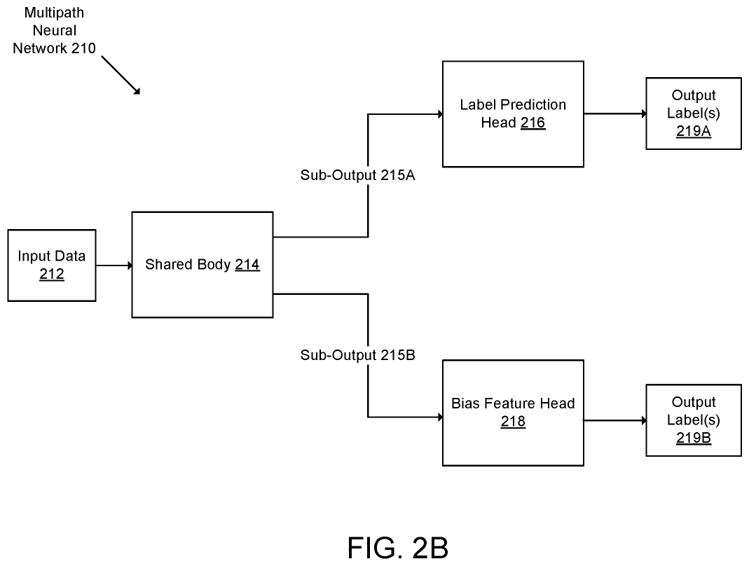

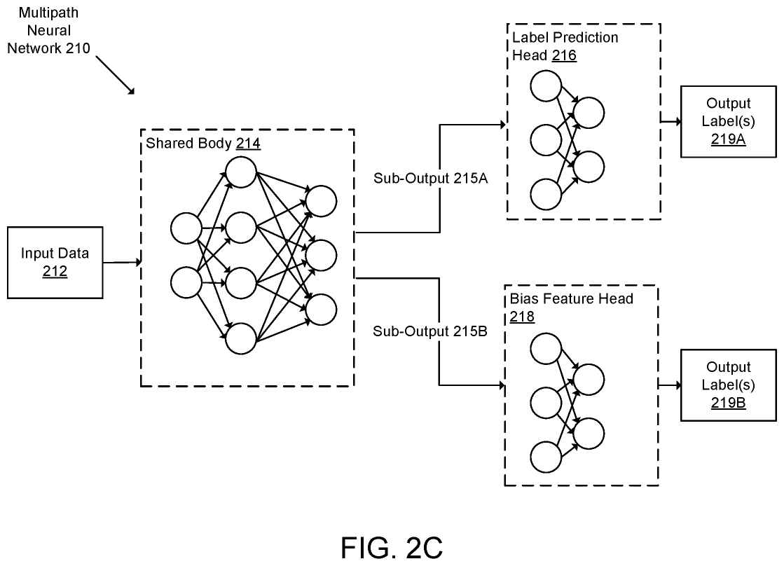

The two different inference generation paths may each operate through ingestion of data (i.e., input) into a shared body. The shared body may include an input layer and one or more hidden layers. The shared body may be connected to two independent heads that each include one or more hidden layers and/or an output layer. Refer to FIGS. 2A-2C for additional details regarding the architecture of the multipath inference model.

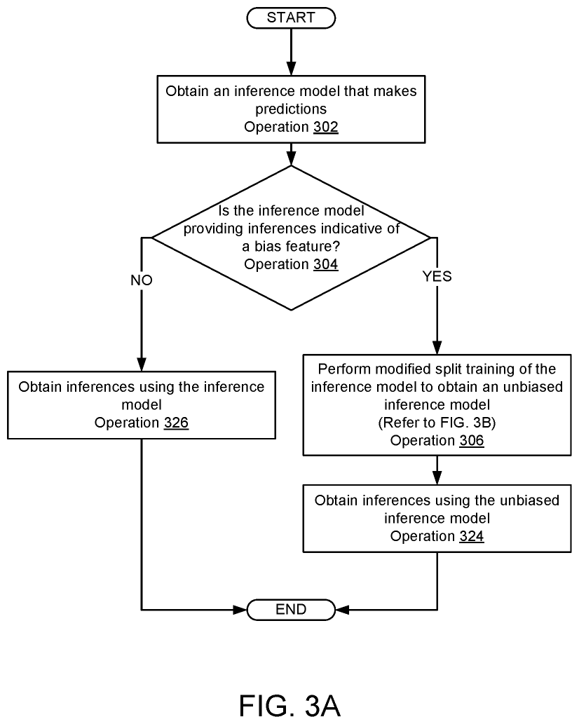

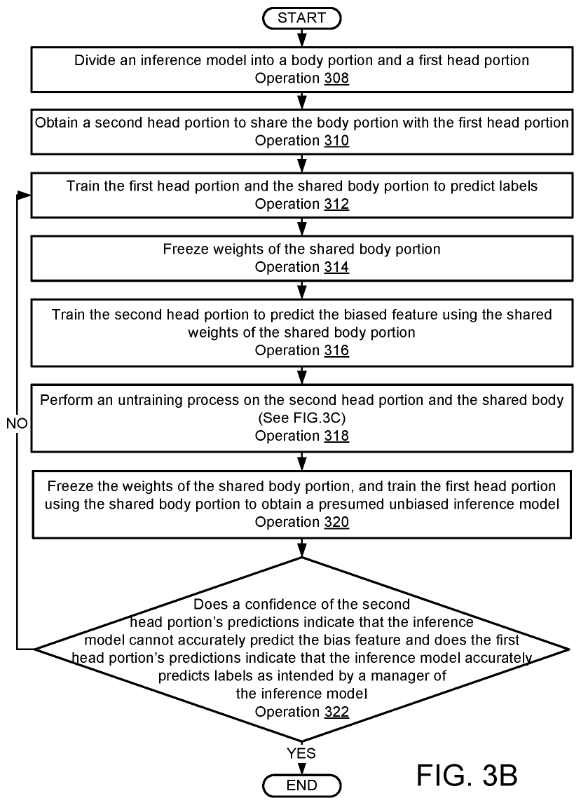

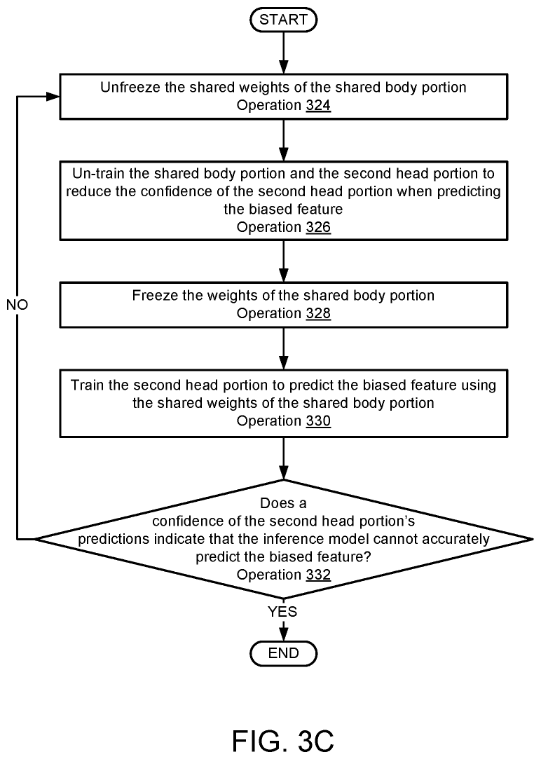

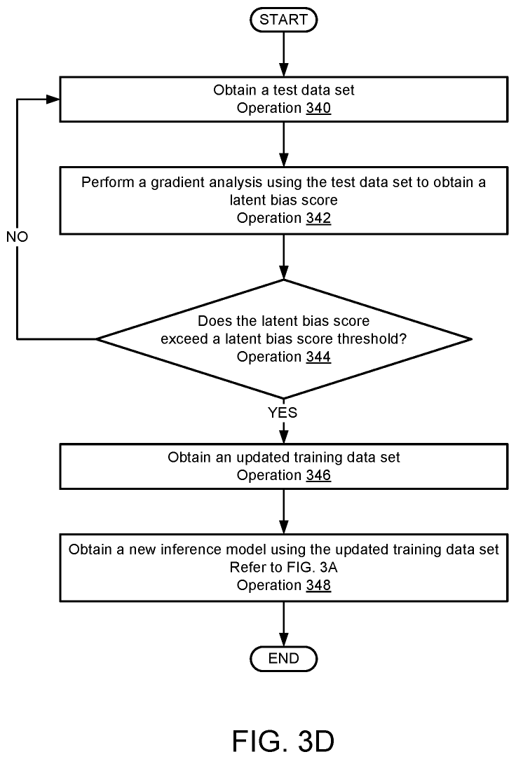

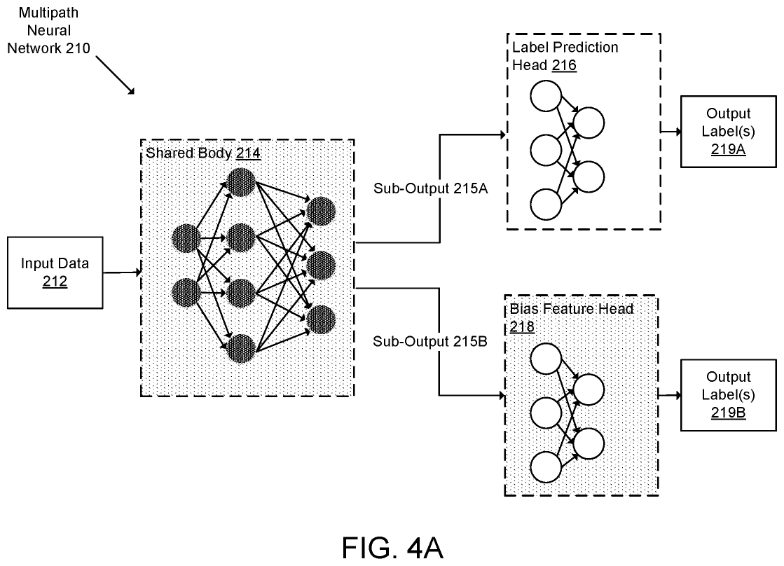

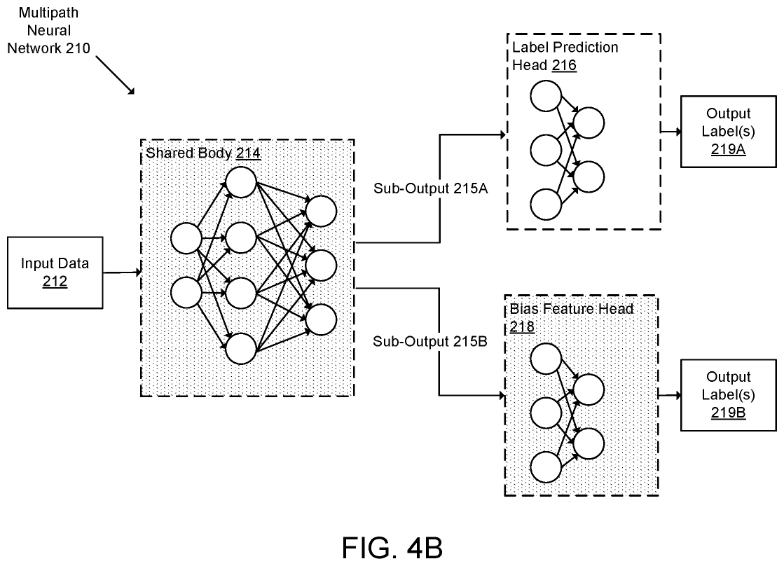

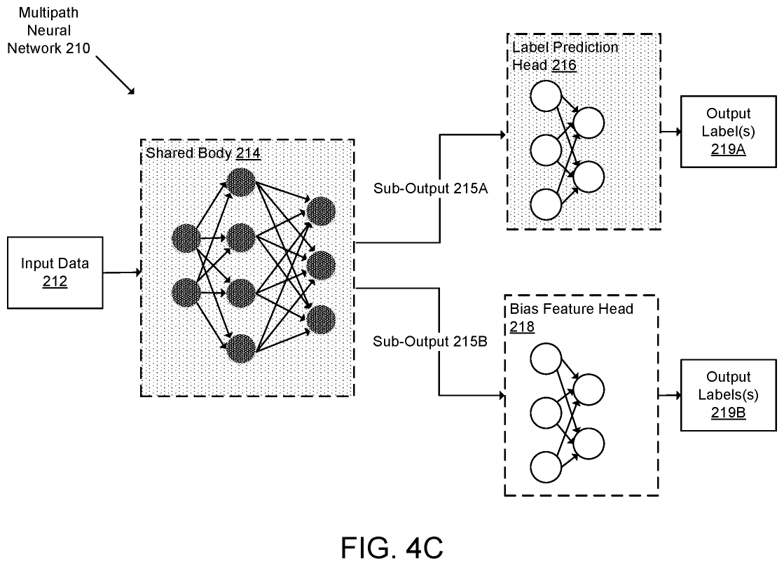

During the modified split training, weights of the shared body may undergo a series of freezes and unfreezes as the inference generation paths are trained. The heads of the respective inference paths may be independently trained to predict the bias feature and a desired feature. During the modified split training, the weights of the body and the respective heads may be fine-tuned. Fine tuning the weights in this manner may increase the likelihood of removing latent bias from the multipath inference model. Refer to FIGS. 3B-4C for additional details regarding modified split training.

However, removing latent bias via modified split training may be unsuccessful and/or may not reduce the latent bias to a degree considered acceptable by a recipient and/or provider of the computer-implemented services. This may occur, for example, due to certain input features in the training data set disproportionally contributing to the latent bias exhibited over time by the inference model. Therefore, rather than modifying the inference model through the above-mentioned split training process (or after failed attempts), a new inference model may be obtained using a modified training data set. The modified training data set may be obtained by removing input features identified as contributing to the inference model's ability to predict the bias feature. The new inference model may replace the old inference model for inference generation purposes. Refer to FIG. 3D for additional details regarding identifying input features in training data that contribute to latent bias in trained inference models.

To provide the above noted functionality, the system may include data processing system 100, client device 102, and communication system 104. Each of these components is discussed below.

Client device 102 may consume all, or a portion, of the computer-implemented services. For example, client device 102 may be operated by a user that uses database services, instant messaging services, and/or other types of services provided by data processing system 100.

Data processing system 100 may provide inference model management services and/or computer-implemented services (e.g., used by client device 102). When doing so, data processing system 100 may (i) identify whether an inference model (e.g., a trained neural network) is making predictions indicative of a bias feature, (ii) obtain an updated instance of the inference model that does not or includes a lesser degree of latent bias via modified split training and/or training a new inference model with a new training data set, (iii) use the updated inference model to obtain inferences that are unencumbered (or less uncambered) by the bias feature, and/or (iv) provide computer-implemented services using the obtained inferences.

When performing its functionality, client device 102 and/or data processing system 100 may perform all, or a portion, of the methods and/or actions described in FIGS. 2A-4C.

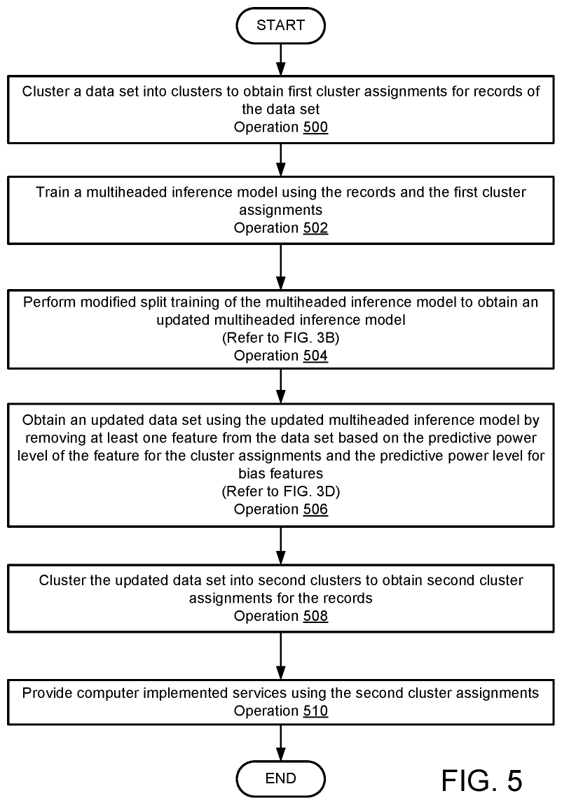

Data processing system 100 and/or client device 102 may be implemented using a computing device such as a host or a server, a personal computer (e.g., desktops, laptops, and tablets), a “thin” client, a personal digital assistant (PDA), a Web enabled appliance, a mobile phone (e.g., Smartphone), an embedded system, local controllers, an edge node, and/or any other type of data processing device or system. For additional details regarding computing devices, refer to FIG. 5.

Any of the components illustrated in FIG. 1 may be operably connected to each other (and/or components not illustrated) with a communication system 104. In an embodiment, communication system 104 may include one or more networks that facilitate communication between any number of components. The networks may include wired networks and/or wireless networks (e.g., and/or the Internet). The networks may operate in accordance with any number and types of communication protocols (e.g., such as the internet protocol).

While illustrated in FIG. 1 as including a limited number of specific components, a system in accordance with an embodiment may include fewer, additional, and/or different components than those illustrated therein.

To further clarify embodiments disclosed herein, inference model diagrams in accordance with an embodiment are shown in FIGS. 2A-2C. The inference model diagrams may illustrate a structure of the inference models and/or how data is processed/used within the system of FIG. 1.

Turning to FIG. 2A, a diagram illustrating a neural network (e.g., an implementation of an inference model) in accordance with an embodiment is shown.

In FIG. 2A, neural network 200 may be similar to the inference model of data processing system 100, discussed above. Neural network 200 may include a series of layers of nodes (e.g., neurons, illustrated as circles). This series of layers may include input layer 202, hidden layer 204 (which may include different sub-layers of neurons), and output layer 206. Lines terminating in arrows in this diagram indicate data relationships (e.g., weights). For example, numerical values calculated with respect to each of the neurons during operation of neural network 200 may depend on the values calculated with respect to other neurons linked by the lines (e.g., the weight associated with each line may impact the level of dependence of the value for a second neuron for the value for neuron from which the line initiates). The value calculated with respect to a first neuron may be based, at least in part, on the values of other neurons from which the arrows that terminate in the neuron initiate from.

Each of the layers of neurons of neural network 200 may include any number of neurons and may include any number of sub-layers.

Neural network 200 may exhibit latent bias when trained using training data that was obtained using a dataset that includes a bias feature, and/or data that is highly correlated with the bias feature, as discussed above. For example, neural network 200 may be trained to determine a credit limit for an individual applying for a credit line. Neural network 200 may be trained to ingest input data such as, income, number of dependents, shopping locations, etc. Neural network 200 may also be trained to output a value indicating a credit limit for the individual. The credit limit may be used by a financial institution to decide which financial offers to provide to different persons.

However, depending on the training data and training process, neural network 200 may exhibit latent bias that is based on a correlation in the training data between the lowest credit limits suggested by the network and potential clients who are a part of a protected class (e.g., clients who all are of a particular ethnicity such as Latino, or are all of a particular gender such as women, etc.). Such latent bias may arise even when, for example, neural network 200 does not ingest, as input, any explicit information regarding these characteristics of the potential clients. In this example, neural network 200 may be determined as making predictions indicative of latent bias, the latent bias being a correlation between the protected class and the lowest credit limits in the predictions.

To manage presence of bias features, embodiments disclosed herein may provide a system and method that is able to reduce and/or eliminate such bias features indicated by predictions made by inferences models. To do so, the system may modify the architecture of neural network 200. Refer to FIGS. 2B-2C for additional details regarding these modifications to the architecture of neural network 200 to manage bias features.

Turning to FIGS. 2B-2C, diagrams illustrating data structures and interactions within an inference model in accordance with an embodiment are shown.

In FIG. 2B, a diagram of multipath neural network 210 is shown. Multipath neural network 210 may be derived from neural network 200 shown in FIG. 2A. Multipath neural network 210 may be derived by (i) obtaining shared body 214 based on neural network 200 and (ii) adding two heads. The shared body and one head may be members of a first inference generation path and the shared body and other head may be members of a second inference generation path (it will be appreciated that other inference generation paths may be similarly obtained). Input data 212 may be any data to be ingested by multipath neural network 210.

Input data 212 may be ingested by shared body 214. Shared body 214 may include an input layer (e.g., input layer 202 of FIG. 2A) and one or more hidden layers (e.g., a portion of the sub-layers of hidden layer 204 of FIG. 2A).

During operation, shared body 214 may generate intermediate outputs (e.g., sub-output 215A-215B) consumed by the respective heads (e.g., 216, 218) of multipath neural network 210.

Label prediction head 216 may include some number of hidden layers (e.g., that include weights that depend on the values of nodes of shared body 214), and an output layer through which output label(s) 219A are obtained. Similarly, bias feature head 218 may include some number of hidden layers (e.g., that include weights that depend on the values of nodes of shared body 214), and an output layer through which output label(s) 219B are obtained. Output label(s) 219A and 219B may be the inferences generated based on input data 212 by multipath neural network.

A first inference generation path may include shared body 214 and label prediction head 216. This first inference generation path may, upon ingestion of input data 212, generate output label(s) 219A. The first inference generation path may attempt to make predictions as intended by neural network 200.

A second inference generation path may include shared body 214 and bias feature head 218. This second inference generation path may, upon ingestion of input data 212, generate output label(s) 219B. The second inference generation path may attempt to make predictions of an undesired bias feature indicated by predictions made by neural network 200.

Any of shared body 214, label prediction head 216, and bias feature head 218 may include neurons. Refer to FIG. 2C for additional details regarding these neurons.

Turning to FIG. 2C, a diagram illustrating multipath neural network 210 in accordance with an embodiment is shown. As seen in FIG. 2C, shared body 214, label prediction head 216, and bias feature head 218 may each include layers of neurons. Each of shared body 214, label prediction head 216, and bias feature head 218 may include similar or different numbers and arrangements of neurons.

While not illustrated in FIG. 2C, the values for some of the neurons of label prediction head 216 and bias feature head 218 calculated during operation of multipath neural network 210 may depend on the values calculated for some of the neurons of shared body 214. These dependences (i.e., weights) are represented by sub-output 215A and sub-output 215B.

While illustrated in FIGS. 2A-2C as including a limited number of specific components, a neural network and/or multipath neural network may include fewer, additional, and/or different components than those illustrated in these figures without departing from embodiments disclosed herein.

As discussed above, the components and/or data structures of FIG. 1 may perform various methods to provide inference model management services in a manner that reduces the likelihood of an inference model providing inferences (predictions) indicative of a bias feature. FIGS. 3A-3B illustrate methods that may be performed by the components of FIGS. 1. In the diagrams discussed below and shown in these figures, any of the operations may be repeated, performed in different orders, omitted, and/or performed in parallel and/or a partially overlapping in time manner with other operations.

Turning to FIG. 3A, a flow diagram illustrating a method of managing an inference model in accordance with an embodiment is shown. The method may be performed, for example, by a data processing system, a client device, a communication system, and/or other components and/or data structures illustrated in FIGS. 1-2C.

At operation 302, an inference model that makes predictions is obtained (e.g., a trained neural network). The inference model may be obtained through various processes such as (i) generation through training with a training data set, (ii) acquisition from an external entity, and/or (iii) by other process.

For example, an inference model may be received from another entity through a communication system (e.g., communication system 104). In a second example, an inference model may be obtained using a set of training data and a training system through which values of weights of a neural network are set. In the second example, the set of training data may be used in concert with a machine learning model (and/or other type of inference generation model) to obtain the inference model based on relationships defined by the set of training data (which may lead to latent biased being introduced into the inference model).

At operation 304, a determination is made regarding whether the inference model is providing inferences indicative of a bias feature. The determination may be made by identifying correlations between the outputs of the inference model and, for example, protected class data (e.g., characterizations of individuals such as, but not limited to, race and/or sex,) or other types of features that may not be desired. If a level of the correlation exceeds a threshold, then it may be determined that the inferences exhibit latent bias.

The determination is made by presuming that any newly generated inference model provides inferences indicative of a bias feature. The presumed bias feature may be one or more based on a regulatory environment to which an organization using the inference model is subject.

If the inference model is determined to be providing inferences indicative of the bias feature, then the method may proceed to operation 306. Otherwise, the method may proceed to operation 326.

At operation 306, modified split training of the inference model is performed to obtain an unbiased inference model. The modified split training may be performed by (i) obtaining a multipath inference model using the inference model, and (ii) using a co-training process, (a) training one of the inference paths of the multipath inference model to infer the labels (outputs) that the inference model was trained to infer and (b) training the other inference path to be unable to predict the bias feature. The one of the inference paths may be used as the unbiased inference model.

As noted above, inference models may be presumed to make predictions indicative of bias features. Modified split training for these inference models may be automatically performed for any number of the presumed bias features. Refer to FIG. 3B for additional details regarding the modified split training.

At operation 324, inferences are obtained using the unbiased inference model. The inferences may be obtained using the unbiased inference model by ingesting input data into the unbiased inference model. The unbiased inference model may output the inferences (e.g., for the labels intended to be generated by the inference model obtained in operation 302).

The method may end following operation 324.

Returning to operation 304, the method may proceed to operation 326 when inference models are determined to be making inferences that are not indicative of the bias feature.

At operation 326, inferences are obtained using the inference model (e.g., obtained in operation 302). The inferences may be obtained using the inference model by ingesting input data into the inference model. The inference model may output the inferences (e.g., for the labels intended to be generated by the inference model obtained in operation 302).

The method may end following operation 326.

Turning to FIG. 3B, a flow diagram illustrating a method of obtaining an unbiased inference model in accordance with an embodiment is shown. The method may be performed, for example, by a data processing system, a client device, a communication system, and/or other components illustrated in FIG. 1.

At operation 308, an inference model (e.g., the inference model obtained in operation 302) is divided to obtain a shared body. The inference model may be divided by splitting the inference model. The shared body portion may include an input layer and one or more hidden layers.

A label prediction head may also be obtained. For example, from the remaining portion of the divided inference model that is not part of the shared body may be used as the label prediction head (e.g., a first head portion). The label prediction head may include one or more hidden layers and an output layer.

At operation 310, a second head portion is obtained. The second head portion may be obtained by (i) duplicating the label prediction head, (ii) generating a structure that may or may not include different numbers of neurons in the layers and/or different numbers of layers than that of the label prediction head, and/or (iii) via other processes. The second head portion may be a bias feature head, as discussed above.

At operation 312, the first head portion and the shared body portion are trained to predict labels (e.g., output labels 219A). This training may be regarded as a preparation training procedure. The first inference generation path may be trained to predict the labels by (i) using training data obtained for training of the inference model as intended by a manager of the inference model, and (ii) using the training data obtained to train the inference model in operation 302.

At operation 314 weights of the shared body portion are frozen. The weights (henceforth referred to as “the shared weights”) may be frozen by placing the shared weights in an immutable state. This immutable state may prevent the shared weights from changing values during training. In contrast, while unfrozen, the shared weights may be modified through training.

At operation 316, the second head portion is trained to predict a bias feature (e.g., the bias feature discussed with respect to operation 304) using the frozen shared weights of the shared body portion. This training may be regarded as a first training procedure. The second head portion may be trained to predict the bias feature by (i) identifying the bias feature based on a previously identified correlation (as discussed with respect to FIG. 3A) to obtain bias feature training data, and (ii) bias feature training the second inference generation path using the bias feature training data.

The bias feature training data may establish a relationship (i.e., the correlation) between the input of the training data used to obtain the inference model and the bias feature.

By doing so, the second inference generation path may be trained to predict the bias feature with a high level of confidence. During the first training procedure, the weights of the shared body may be frozen while the weights of the bias feature head may be unfrozen.

At operation 318, an untraining process is performed on the second head portion and the body portion. As noted above, inference models may be presumed to make predictions indicative of a bias feature and the second inference generation path may be trained in a manner that causes the second inference generation path to be unable to predict the bias feature. This untraining process of the second inference generation path may be automatically performed for any number of the presumed bias features. Refer to FIG. 3C for additional details regarding the untraining process.

At operation 320 the shared weights of the shared body portion are frozen (as described with respect to operation 314) and the first head portion is trained using the shared body portion to obtain an unbiased inference model. This training may be regarded as a second training procedure. The shared body and the first head portion (e.g., in aggregate, the first inference generation path) may be trained by using training data upon which the original inference model was trained.

By freezing the weights of the shared body during the second training procedure, latent bias may be less likely or prevented from being introduced into the first inference generation path. Thus, during the second training procedure, only the weights of the label prediction head may be modified.

At operation 322 a second determination is made regarding whether a predictive ability of the second head portion's predictions indicate that the inference model cannot accurately predict the bias feature and/or that the first head portion's predictions can accurately predict the labels intended to be generated by the inference model obtained in operation 302. The second determination may be made by testing the confidence of the second inference generation path when predicting the bias feature and testing the confidence of the first inference generation path when predicting the labels.

The second head portion's predictions may be determined to be inaccurate when the confidence of the second head portion's predictions is not within a first predefined threshold. Otherwise, it may be determined that the second head portion's predictions are accurate, and therefore, the confidence may be within the second predefined threshold.

Additionally, the second determination may include testing the predictive power of the first inference generation path when making predictions, the predictive power indicating whether the first inference generation path is capable of making accurate predictions. The first inference generation path may be determined to be making accurate predictions when the predictive power of the first inference generation path's predictions is within a second predefined threshold. Otherwise, it may be determined that the first inference generation path's predictions are inaccurate, and therefore, the confidence may not be within the second predefined threshold.

If the confidence is determined to not be within the first predefined threshold (e.g., sufficiently low), and the predictive power is within the second predefined threshold, then the method may end following operation 322. If the confidence is determined to be within the first predefined threshold (e.g., sufficient high), and/or the predictive power is not within the second predefined threshold, then the method may loop back to operation 312 (to repeat operations 312-320). It will be appreciated that upon completion of the second determination that the weights of the shared body are to be unfrozen.

By looping back through operations 312-320, the level of latent bias in the shared body portion may be progressively reduced until it falls below a desired level (e.g., which may be established based on the first predefined threshold).

Returning to FIG. 3A, the method may proceed to operation 324 following operation 306.

Turning to FIG. 3C, a flow diagram illustrating a method of performing an untraining procedure on an inference model in accordance with an embodiment is shown. The method may be performed, for example, by a data processing system, a client device, a communication system, and/or other components illustrated in FIGS. 1. The method may also be performed, for example, on the multipath inference model discussed with regard to FIG. 3A-3B.

At operation 324, the shared weights of the shared body portion are unfrozen. In contrast to operation 314, the shared weights may be unfrozen by placing the shared weights in a mutable state. This mutable state may allow the shared weights to change values during training.

At operation 326, the shared body portion and the second head portion (the second inference generation path) are un-trained (e.g., with respect to the bias feature) to reduce the predictive ability for predicting the bias feature. This un-training may be referred to as an untraining procedure.

To perform the untraining, the second inference generation path may be un-trained by utilizing, for example, a gradient ascent process (in contrast to a gradient descent process for optimizing inferences made by inference models) to increase the inaccuracy and/or reduce the predictive ability of the second inference generation path when inferring the bias feature based on ingest data. In contrast to operation 316, during operation 326 the weights of both the shared body and bias prediction head may be modified thereby reducing the latent bias in the shared body portion.

It will be appreciated that, as noted above, any of the operations may be performed multiple times. For example, operations 324-332 may be performed more than once prior to performing operation 320. The number of times operation 324 is performed may be selected, for example, to reduce the level of latent bias exhibited by the second inference generation path by a predetermined amount or a predetermined level.

At operation 328, the weights of the shared body portion are frozen. The weights (henceforth referred to as “the shared weights”) may be frozen by placing the shared weights in an immutable state, as described with respect to operation 314. This immutable state may prevent the shared weights from changing values during training. In contrast, while unfrozen, the shared weights may be modified through training.

At operation 330, the second head portion is trained to predict the bias feature (e.g., the bias feature discussed with respect to operation 304) using the frozen shared weights of the shared body portion, as described with respect to operation 316.

By doing so, the second inference generation path may be recalibrated to predict the bias feature with the shared changed body. The weights of the shared body may be frozen while the weights of the bias feature head may be unfrozen.

At operation 332 a third determination is made regarding whether a predictive ability of the second head portion's predictions indicate that the inference model cannot accurately predict the bias feature. The third determination may be made by testing the confidence of the second inference generation path when predicting the bias feature.

The second head portion's predictions may be determined to be inaccurate when the predictive ability of the second head portion's predictions is not within a first predefined threshold (similarly described with respect to FIG. 3B). It will be appreciated that in some instances the threshold may be different to that discussed with respect to FIG. 3B.

If the predictive ability is determined to not be within the first predefined threshold (e.g., sufficiently low), then the method may end following operation 332. If the confidence is determined to be within the first predefined threshold (e.g., sufficient high), then the method may loop back to operation 324 (to repeat operations 324-330).

By looping back through operations 324-330, the level of latent bias in the shared body portion may be progressively reduced until it falls below a desired level (e.g., which may be established based on the first predefined threshold).

Using the methods illustrated in FIGS. 3A-3C, embodiments disclosed herein may facilitate management of inference models which may reduce the likelihood of the inference models making inferences indicative of a bias feature despite limited training data. For example, by using modified split training to manage inference models, inference models may be more reliable in providing inferences that do not lead to discrimination of an individual based on protected class data associated with the individual and/or otherwise including latent bias.

Turning to FIG. 3D, a flow diagram illustrating a method for identifying input features contributing to latent bias exhibited by the inference model in accordance with an embodiment is shown. The method may be performed, for example, by a data processing system, a client device, a communication system, and/or other components illustrated in FIG. 1. The method may also be performed, for example, on the multipath inference model discussed with regard to FIG. 3A-3C.

At operation 340, a test data set is obtained. The test data set may include at least a portion of the first training data set. The first training data set may include a listing of entries. To obtain the test data set, the first training data set may be obtained and one or more of the following steps may be performed for each entry in the listing of entries of the first training data set: (i) obtaining an input, an output, and a bias feature label, (ii) obtaining a subset of input features associated with the input, (iii) obtaining a new entry for the test data set using the subset of the input features, and/or (iv) adding the new entry to the test data set. These steps may be performed for each entry in the first training data set to obtain a test data set with the same number of entries as the first training data set.

Obtaining the first training data set may include reading the first training data set from storage, requesting the first training data set from another entity responsible for managing and/or generating training data sets, and/or obtaining credentials to access a database where the first training data set is stored.

Obtaining the input, output, and bias feature label may be performed by obtaining a first entry of the listing of entries included in the training data set. The first entry of the listing of the entries may include an input and an output. If the input and output are not included in the entry, the entry may include instructions for how to retrieve the input and output from another location (e.g., storage). The bias feature label may not be included in the entry. To obtain the bias feature label, the bias feature label may be requested from another entity responsible for storing additional information regarding the first training data set. The bias feature label may also be generated by requesting the bias feature label (e.g., a user's age) from the user themselves via an email, text message, and/or notification through an application on a device. The bias feature label may be obtained via other methods without departing from embodiments disclosed herein.

The subset of the input features associated with the input may be obtained by identifying a listing of input features associated with each entry of the first training data set and selecting a subset of the input features from the listing of the input features. Selecting the subset of the input features may be performed by randomly choosing a subset of the input features, by systematically choosing subsets of different sizes and compositions, and/or by transmitting the input features to another entity and receiving subsets of the input features as a response from the entity responsible for selecting the subsets of the input features.

The new entry for the test data set may be obtained by generating a data structure and populating the data structure with the new entry. The new entry may include an input (including the subset of the input features), the output, and the bias feature label. The new entry may be obtained by transmitting the subset of input features, the output, and the bias feature label to another entity responsible for generating the new entry. The new entry may be obtained via other methods without departing from embodiments disclosed herein.

The new entry may be added to the test data set by generating a data structure (e.g., a blank or partially populated data set) and populating the data structure with the new entry. The new entry may also be transmitted to another entity responsible for compiling the test data set using the new entry.

At operation 342, a gradient analysis is performed using the test data set to obtain a latent bias score for the test data set. The latent bias score may indicate a relationship between input features of the test data set (e.g. the subset of input features selected from the first training data set) and the inference model's ability to predict a bias feature (e.g., the bias feature corresponding to the bias feature labels in each entry of the test data set).

The gradient analysis may be performed by: (i) obtaining a listing of partial latent bias scores, and (ii) adding the partial listing of bias scores of the listing of bias scores to obtain the latent bias score.

To obtain a listing of partial latent bias scores, any of the following steps may be performed for each entry in the test data set: (i) obtaining a first gradient, (ii) obtaining a second gradient, (iii) adding the first gradient and the second gradient to obtain a first partial latent bias score, and/or (iv) adding the first partial latent bias score to the listing of the partial latent bias scores.

The first gradient may indicate a relationship between the input and the inference model's ability to predict the output. The first gradient may be obtained by: (i) obtaining an output inference using the inference model and the input as ingest for the inference model, the output inference being intended to match the output associated with the input, and/or (ii) obtaining the local feature's contribution to faithfully predicting the output. The first gradient may be obtained via other methods (e.g., transmitting the first entry to another entity responsible for obtaining the first gradient) without departing from embodiments disclosed herein.

The output inference may be obtained using a first inference generation path of the inference model. The first inference generation path may include a shared body portion and a first head portion. The shared body portion and the first head portion may each include, for example, a number of neurons (or layers of neurons) of a neural network inference model. The first inference generation path may be trained to generate inferences to predict the output. Refer to FIGS. 2A-2C for additional details regarding the architecture of the inference model.

To obtain the first gradient, a function representing the output inferences over the entire range of the input values in the test data set may be obtained. The first gradient may be the gradient of the function at the point specified by the first entry of the test data set. The gradient may be a negative number if the input features increase the likelihood that the inference model will faithfully predict the output. A larger negative first gradient may indicate a stronger relationship between the input and the inference model's ability to faithfully predict the output.

The second gradient may indicate a relationship between the input and the inference model's ability to faithfully predict the bias feature label. The second gradient may be obtained by: (i) obtaining a bias inference using the inference model and the input as ingest for the inference model, the bias inference being intended to match the bias feature label associated with the input, and (ii) obtaining the second gradient based on the input's contribution to faithfully predicting the bias feature. The second gradient may be obtained via other methods (e.g., transmitting the first entry to another entity responsible for obtaining the second gradient) without departing from embodiments disclosed herein.

The bias inference may be obtained using a second inference generation path of the inference model. The second inference generation path may include the shared body portion and a second head portion. The shared body portion and the second head portion may each include, for example, a number of neurons (or layers of neurons) of a neural network inference model. The second inference generation path may be trained to generate inferences to predict the bias feature. Refer to FIGS. 2A-2C for additional details regarding the architecture of the inference model.

To obtain the second gradient, a loss function representing the inference model's ability to faithfully predict the bias feature over the entire range of the input values in the test data set may be obtained. The second gradient may be the gradient of the loss function at the point specified by the first entry. The second gradient may be a negative number if the input features increase the likelihood that the inference model will faithfully predict the bias feature label. A negative second gradient with a larger magnitude may indicate a stronger relationship between the input and the inference model's ability to faithfully predict the bias feature.

The first partial latent bias score may be obtained by: (i) obtaining a scalar value associated with the first gradient and a scalar value associated with the second gradient, and (ii) performing an addition process by adding the scalar value associated with the first gradient to the scalar value associated with the second gradient. The first gradient and the second gradient may be added by transmitting the first gradient and the second gradient to another entity responsible for generating partial latent bias scores.

The first partial latent bias score may be added to the listing of partial latent bias scores by generating a data structure and populating the data structure with the first partial latent bias score. The listing of partial latent bias scores may be generated by another entity and/or the first partial latent bias score may be transmitted to another entity responsible for compiling the listing of partial latent bias scores.

The latent bias score may be obtained by obtaining the listing of partial latent bias scores and adding the scalar values associated with each partial latent bias score in the listing of partial latent bias scores. The latent bias score may also be obtained by transmitting the listing of partial latent bias scores to another entity responsible for adding the partial latent bias scores to obtain the latent bias score. The latent bias score may include a scalar value that is either positive or negative. A positive latent bias score may indicate that the subset of input features included in the input of the test data set may contribute more strongly to the inference model's ability to faithfully predict the output than the inference model's ability to faithfully predict the bias feature. A negative latent bias score may indicate that the subset of input features included in the input of the test data set may contribute more strongly to the inference model's ability to faithfully predict the bias feature than the inference model's ability to faithfully predict the output.

At operation 344, it is determined whether the latent bias score exceeds a latent bias score threshold. The latent bias score threshold may be exceeded when the latent bias score is negative and has a magnitude that exceeds a magnitude indicated by the latent bias threshold. For example, the latent bias score threshold may be −1.56. Therefore, any test data set with an associated negative latent bias score with a magnitude that is greater than 1.56 may exceed the inference bias score threshold. If the latent bias score exceeds the latent bias score threshold, the method may proceed to operation 346. If the latent bias score does not exceed the latent bias score threshold, the method may return to operation 340.

At operation 346, an updated training data set is obtained. To obtain the updated training data set, the input features of the test data set may be removed from the first training data set. Removing the input features of the test data set from the first training data set may include: (i) obtaining the listing of the input features associated with the input of the first training data set, (ii) removing the input features associated with the test data set from each entry of the first training data set, and (iii) treating the remaining input features as the input features of the updated training data set.

At operation 348, a new inference model is obtained using the updated training data set. The new inference model may be obtained in order to replace the inference model. The new inference model may be obtained as described in operation 302 of FIG. 3A but using the updated training data set in place of the training data set. Refer to FIG. 3A for additional details regarding obtaining inference models.

The method may end following operation 348.

To further clarify embodiments disclosed herein, an example implementation in accordance with an embodiment is shown in FIGS. 4A-4C. These figures show diagrams illustrating data structures and interactions during management of an inference model in accordance with an embodiment. While described with respect to inference model management services, it will be understood that embodiments disclosed herein are broadly applicable to different use cases as well as different types of data processing systems than those described below.

Consider a scenario in which a bank offers various loans (of varying amounts) over time to clients of the bank. The bank may utilize an inference model (e.g., a neural network) to determine a loan amount to offer its clients. The inference model may be trained to ingest input such as mortgage, credit debt, types of purchases, etc. of a client. The inference model may proceed to output a value corresponding to a loan amount to offer the client.

Assume that over time a correlation between low loan amounts and a race of the clients (e.g., clients of African American descent) is identified in the inferences generated by the neural network. To avoid perpetuating discrimination towards clients of the particular race, the bank may utilize modified split training to manage the inference model (as discussed previously). This management of the inference model may reduce the likelihood of there being bias associated with the inferences made by the inference model. By doing so, a neural network (similar to neural network 200 of FIG. 2A) may be divided to obtain a multipath inference model (similar to multipath neural network 210 of FIG. 2C).

As shown in FIGS. 4A-4C, once the two inference generation paths have been obtained (first and second inference generation paths as discussed with respect to FIG. 2A-2C), a series of training procedures (as part of the modified split training) may be executed.

Turning to FIG. 4A, a diagram illustrates a first training procedure for the second inference generation path of multipath neural network 210 in accordance with an embodiment is shown. The training procedure may set weights the second inference generation path to predict the bias feature (e.g., ingested input that is identified as causing the correlation). This first training procedure is characterized by freezing the weights of the nodes in shared body 214 (illustrated as a dark infill with white dots within the nodes). To perform the first training procedure, the second inference generation path may be trained. The portions of multipath neural network 210 trained during the first training procedure are illustrated by a dotted black infill on white background in both shared body 214 and bias feature head 218). Completion of the first training procedure may provide a revised second inference generation path in which the bias feature is predicted with high confidence from the revised second inference generation path.

Turning to FIG. 4B, a diagram illustrates an untraining procedure for the second inference generation path of multipath neural network 210 in accordance with an embodiment is shown. The untraining procedure may set weights second inference generation path such that the second inference generation path is less able to predict bias features. The untraining procedure may be performed to remove influence of the bias feature on shared body 214. In contrast to FIG. 4A, the weights of shared body 214 that were frozen during the first training procedure may be unfrozen (e.g., graphically illustrated in FIG. 2B by the circular elements representing the nodes being filled with solid white infill) to allow for the values of the weights to change. Completion of this untraining procedure may provide a shared body 214 that includes reduced levels of latent bias for the bias feature. By doing so, the untraining procedure may cause the bias feature to be predicted with reduced confidence.

Turning to FIG. 4C, a diagram illustrates a second training procedure for the first inference generation path of multipath neural network 210 in accordance with an embodiment is shown. The second training procedure may set weights for the first inference generation path such that the first inference generation path is better able to predict desired features (e.g., labels for which an original inference model was trained to infer). Similar to the first training procedure, weights of the nodes of shared body 214 (illustrated as a dark infill with white dots within the nodes) may be frozen while weights of label prediction head 216 may be unfrozen during second training procedure. To perform the second training procedure, the first inference generation path may be trained (illustrated by black dotted infill on white background in both shared body 214 and label prediction head 216). Completion of this second training procedure may provide an unbiased inference model (e.g., or at one that includes reduced levels of latent bias, the unbiased inference model may be based on the first inference generation path) for the bank to use.

Thus, as illustrated in FIGS. 4A-4C, embodiments disclosed herein may facilitate reduction and/or remove of latent bias in inference models used to provide computer-implemented services. Thus, the provided computer-implemented services may be provided in a manner that is more likely to meet expectations of consumers of the services.

While described with respect to supervised learning with labeled data sets, the methods disclosed herein may be broadly applicable to a wide range of learning methods. For example, the disclosed processes for addressing latent bias may be used to address latent bias that may be introduced through clustering or other types of unsupervised learning.

Turning to FIG. 5, a flow diagram illustrating a method of providing computer implemented services using clustering techniques in accordance with an embodiment is shown. The method may be performed, for example, by a data processing system, a client device, a communication system, and/or other components and/or data structures illustrated in FIGS. 1-4C. Any of the operations shown in FIG. 5 may be repeated, performed in different orders, omitted, and/or performed in parallel and/or a partially overlapping in time manner with other operations.

At operation 500, a data set may be clustered into clusters to obtain first cluster assignments for records of the data set. The clustering may be performed using any clustering technique (e.g., distance based, similarity based, etc.). The resulting first cluster assignment may group the records into various clusters.

However, the groupings may exhibit latent bias. For example, as noted above, hidden correlations between features in the data set and bias features may be present in the data set. Consequently, the resulting first cluster assignments may exhibit latent bias for one or more bias features.

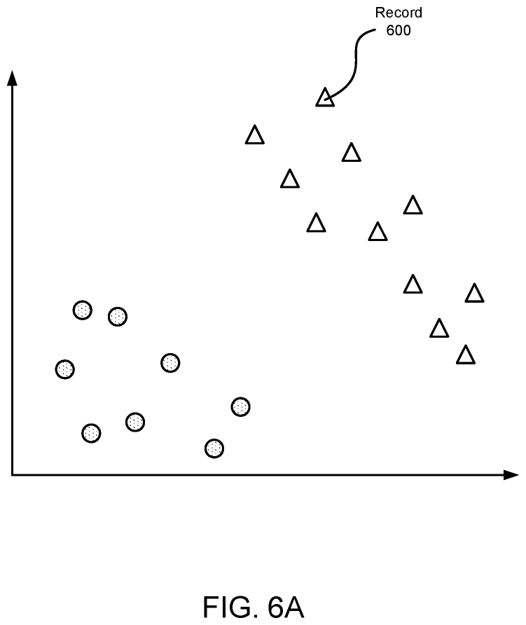

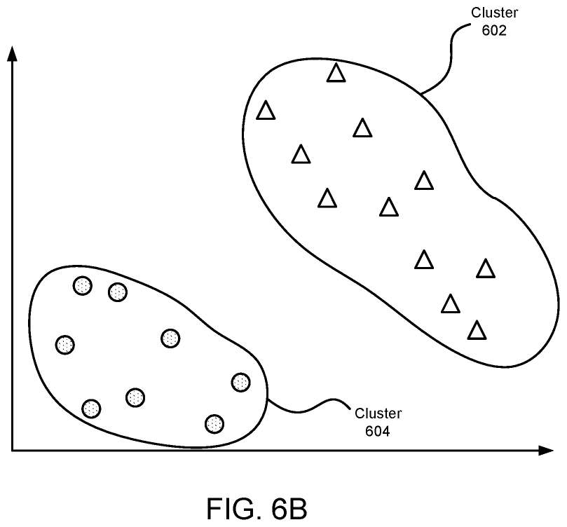

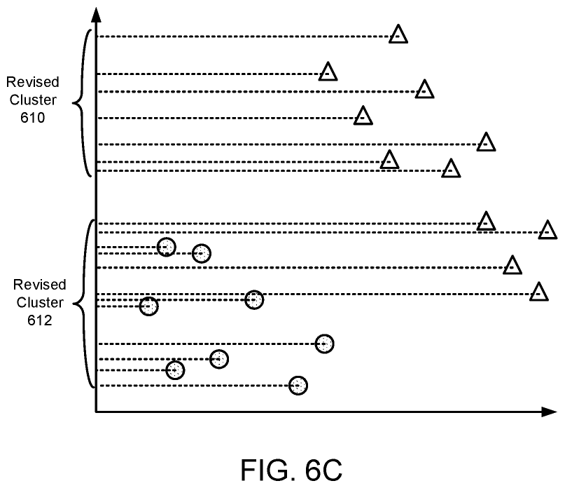

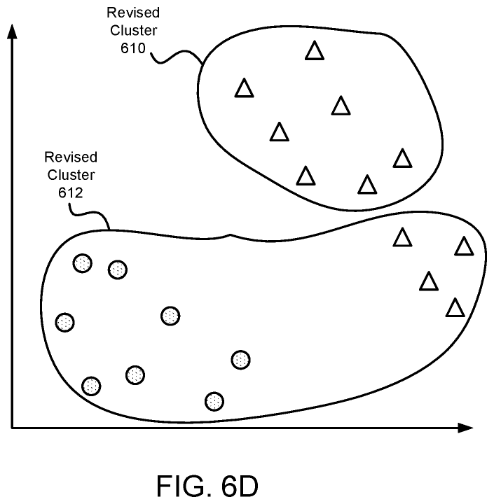

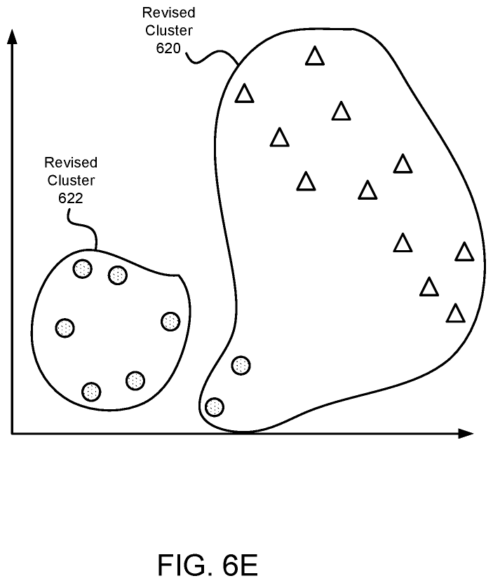

Refer to FIGS. 6A-6B for additional details regarding clustering of a data set.

At operation 502, a multiheaded inference model is obtained using the records and the first cluster assignments. To obtain the multiheaded inference model, (i) a supervised learning technique such as machine learning may be used to train an inference model using the records as features and the first cluster assignments as labels, (ii) the inference model may be divided (e.g., as discussed with respect to operation 308) to obtain a shared body and a first head portion (e.g., a feature head), and (iii) a second head portion (e.g., a bias feature head) may be added (e.g., as discussed with respect to operation 310).

At operation 504, modified split training of the multiheaded inference model may be performed to obtain an updated multiheaded inference model. The modified split training may be performed as described with respect to FIG. 3B.

During the modified split training, the feature head may be trained for predictive power with respect to the cluster assignments, and the bias feature head may be trained to reduce predictive power with respect to the bias features. Consequently, the shared body which participates in both training, may have improved feature predictive power and reduced bias feature predictive power.

At operation 506, an updated data set is obtained using the updated multiheaded inference model by removing at least one feature from the data set based on the predictive power level of the feature for the cluster assignments and the predictive power level for bias features. The updated data set may be obtained using the method described with respect to FIG. 3D.

For example, operations 340-346 may be performed to identify the at least one feature. The feature may then be removed from each of the records of the data set to obtain the updated data set. Consequently, the updated data set may include less information upon which clustering decisions are made, and the removed information may be correlated or otherwise related to the bias features. Accordingly, removal of the feature may change the way in which the updated data set is clustered.

At operation 508, the updated data set is clustered into second clusters to obtain second cluster assignments for the records. The updated data set may be clustered using any clustering technique.

Refer to FIGS. 6C-6D for additional details regarding clustering of an updated data set.

Once the second clusters are obtained, the clusters may be investigated to ascertain whether they exhibit latent bias. If the second clusters exhibit latent bias, then the method may, for example, return to operation 502 to eventually remove an additional feature. This process may be repeated, for example, until a level of the latent bias is reduced to a desirable level.

At operation 510, computer implemented services are provided using the second cluster assignments. For example, the computer implemented services may utilize records from the members of the clusters to provide the services. By virtue of the change in the cluster assignment (when compared to the cluster assignments made using the full data set), the computer implemented services may be provided differently. For example, latent bias may not be introduced into the computer implemented services through use of the second cluster assignments.

The method may end following operation 510.

As discussed above, a data set may be clustered to provide computer implemented services. However, the clustered data may exhibit latent bias. FIGS. 6A-6D show diagrams clustering of data sets in accordance with an embodiment.

Turning to FIG. 6A, a first clustering diagram in accordance with an embodiment is shown. In FIG. 6A, an example set of records (e.g., 600) of a data set are shown. The records of the data set may be associated with financial transactions, and each record may specify an income of an applicant and a credit score of the applicant.

In FIG. 6A, the records are plotted using circular or triangular shaped indicators, the horizontal axis correspond to income level, and the vertical axis corresponds to credit score. Additionally, a bias feature is also shown. For simplicity, the bias feature in this example is a binary classification where triangle shape indicator means a first classification (e.g., whether the applicant is Caucasian) and a circular shaped indicator means a second classification.

Turning to FIG. 6B, a second clustering diagram in accordance with an embodiment is shown. In FIG. 6B, the records have been clustered based on the income and credit score of the applicants with the goal of identifying pools of clients that may qualify for certain financial product offers. The clustering may provide cluster assignments for each of the records to cluster 602 or cluster 604.

However, as seen in FIG. 6B, all of the records that are members of cluster 602 are of a first classification of the bias feature, and all of the records that are members of cluster 604 are of a second classification of the bias feature. Thus, if left as currently clustered, these cluster may exhibit latent bias with respect to the bias feature. For example, if used to make offers to clients, certain types of offers may appear to be made on the basis of the bias feature, even though the bias feature was not used as a basis for extending the offers.

To remediate the latent bias, the method described in FIG. 5 may be performed to obtain a multiheaded inference model (e.g., that predicts membership in the respective clusters and the bias feature), the multiheaded inference model may be split trained, and then an updated data set may be obtained using the trained multiheaded inference model.

Continuing with the example, consider a scenario in which the income of the records was identified as contributing the latent bias and is selected for removal from the data set.

Turning to FIG. 6C, a third clustering diagram in accordance with an embodiment is shown. In FIG. 6C, the records are projected (e.g., indicated by the dashed lines extending between the representations of the records and the vertical axis) onto the vertical axis to indicate that, for clustering purposes, the income specified by the records is not being considered (e.g., because the updated data set does not include it).

When clustering is performed on the updated data set in this example, two revised clusters 610, 612 are established. For example, as seen in FIG. 6C, the projections of the records classified as being members of the respective clusters on the vertical axis may be separated by a significant gap thereby allowing for easy classification.

Turning to FIG. 6D, a fourth clustering diagram in accordance with an embodiment is shown. In FIG. 6D, members in the revised clusters 610, 612 is illustrated. As seen in FIG. 6D, revised cluster 612 may include members that are of varying classifications of the bias feature. Accordingly, the resulting clusters may exhibit reduced levels of latent bias when compared to the level of latent bias exhibited by clusters 602, 604 shown in FIG. 6B.

For example, returning to the financial product offer example, the same offers may be made to clients having different classifications of the bias feature. Thus, reduced levels of latent bias in the offers made on the basis of the clustering may be exhibited.

By identifying and removing features, as described with respect to operations 504-506, embodiments disclosed herein may provide for identification and removal of features that contribute to latent bias to a degree that is greater than that contributed by other features, while balancing predictive power contributed by the features.

For example, turning to FIG. 6E, a fifth clustering diagram in accordance with an embodiment is shown. FIG. 6E shows an example clustering of the dataset where a feature (i.e., credit score) has been randomly removed from consideration for clustering purposes.

As seen in FIG. 6E, removal of the feature from consideration for clustering has changed the clustering to result in revised clusters 620-622. However, these revised clusters still exhibit greater degree of latent bias with respect to the bias feature because, while revised cluster 620 does include records corresponding to different classifications of the bias feature, the cluster is still less heterogenous (with respect to classifications of the bias feature) then revised cluster 612. Consequently, selection of this feature of the data set for removal from consideration for clustering purposes did not reduce the level of latent bias as significantly as the feature that was removed from consideration with respect to revised cluster 612.

Thus, embodiments disclosed herein may facilitate identification and removal of features that provide increased levels of contribution to latent bias while providing lower levels of contribution to feature prediction. By doing, unsupervised learning processes may exhibit reduced latent bias thereby improving the quality of services provided using the results of the unsupervised learning processes.

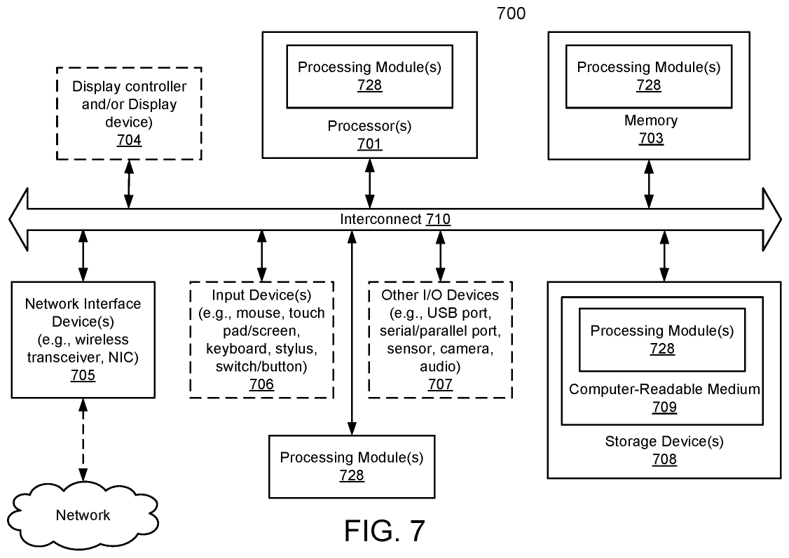

Any of the components illustrated in FIGS. 1-6E may be implemented with one or more computing devices. Turning to FIG. 7, a block diagram illustrating an example of a data processing system (e.g., a computing device) in accordance with an embodiment is shown. For example, system 700 may represent any of data processing systems described above performing any of the processes or methods described above. System 700 can include many different components. These components can be implemented as integrated circuits (ICs), portions thereof, discrete electronic devices, or other modules adapted to a circuit board such as a motherboard or add-in card of the computer system, or as components otherwise incorporated within a chassis of the computer system. Note also that system 700 is intended to show a high level view of many components of the computer system. However, it is to be understood that additional components may be present in certain implementations and furthermore, different arrangement of the components shown may occur in other implementations. System 700 may represent a desktop, a laptop, a tablet, a server, a mobile phone, a media player, a personal digital assistant (PDA), a personal communicator, a gaming device, a network router or hub, a wireless access point (AP) or repeater, a set-top box, or a combination thereof. Further, while only a single machine or system is illustrated, the term “machine” or “system” shall also be taken to include any collection of machines or systems that individually or jointly execute a set (or multiple sets) of instructions to perform any one or more of the methodologies discussed herein.

In one embodiment, system 700 includes processor 701, memory 703, and devices 705-707 via a bus or an interconnect 710. Processor 701 may represent a single processor or multiple processors with a single processor core or multiple processor cores included therein. Processor 701 may represent one or more general-purpose processors such as a microprocessor, a central processing unit (CPU), or the like. More particularly, processor 701 may be a complex instruction set computing (CISC) microprocessor, reduced instruction set computing (RISC) microprocessor, very long instruction word (VLIW) microprocessor, or processor implementing other instruction sets, or processors implementing a combination of instruction sets. Processor 701 may also be one or more special-purpose processors such as an application specific integrated circuit (ASIC), a cellular or baseband processor, a field programmable gate array (FPGA), a digital signal processor (DSP), a network processor, a graphics processor, a network processor, a communications processor, a cryptographic processor, a co-processor, an embedded processor, or any other type of logic capable of processing instructions.

Processor 701, which may be a low power multi-core processor socket such as an ultra-low voltage processor, may act as a main processing unit and central hub for communication with the various components of the system. Such processor can be implemented as a system on chip (SoC). Processor 701 is configured to execute instructions for performing the operations discussed herein. System 700 may further include a graphics interface that communicates with optional graphics subsystem 704, which may include a display controller, a graphics processor, and/or a display device.

Processor 701 may communicate with memory 703, which in one embodiment can be implemented via multiple memory devices to provide for a given amount of system memory. Memory 703 may include one or more volatile storage (or memory) devices such as random access memory (RAM), dynamic RAM (DRAM), synchronous DRAM (SDRAM), static RAM (SRAM), or other types of storage devices. Memory 703 may store information including sequences of instructions that are executed by processor 701, or any other device. For example, executable code and/or data of a variety of operating systems, device drivers, firmware (e.g., input output basic system or BIOS), and/or applications can be loaded in memory 703 and executed by processor 701. An operating system can be any kind of operating systems, such as, for example, Windows® operating system from Microsoft®, Mac OS®/iOS® from Apple, Android® from Google®, Linux, Unix®, or other real-time or embedded operating systems such as VxWorks.

System 700 may further include IO devices such as devices (e.g., 705, 706, 707, 708) including network interface device(s) 705, optional input device(s) 706, and other optional IO device(s) 707. Network interface device(s) 705 may include a wireless transceiver and/or a network interface card (NIC). The wireless transceiver may be a WiFi transceiver, an infrared transceiver, a Bluetooth transceiver, a WiMax transceiver, a wireless cellular telephony transceiver, a satellite transceiver (e.g., a global positioning system (GPS) transceiver), or other radio frequency (RF) transceivers, or a combination thereof. The NIC may be an Ethernet card.

Input device(s) 706 may include a mouse, a touch pad, a touch sensitive screen (which may be integrated with a display device of optional graphics subsystem 704), a pointer device such as a stylus, and/or a keyboard (e.g., physical keyboard or a virtual keyboard displayed as part of a touch sensitive screen). For example, input device(s) 706 may include a touch screen controller coupled to a touch screen. The touch screen and touch screen controller can, for example, detect contact and movement or break thereof using any of a plurality of touch sensitivity technologies, including but not limited to capacitive, resistive, infrared, and surface acoustic wave technologies, as well as other proximity sensor arrays or other elements for determining one or more points of contact with the touch screen.

IO devices 707 may include an audio device. An audio device may include a speaker and/or a microphone to facilitate voice-enabled functions, such as voice recognition, voice replication, digital recording, and/or telephony functions. Other IO devices 707 may further include universal serial bus (USB) port(s), parallel port(s), serial port(s), a printer, a network interface, a bus bridge (e.g., a PCI-PCI bridge), sensor(s) (e.g., a motion sensor such as an accelerometer, gyroscope, a magnetometer, a light sensor, compass, a proximity sensor, etc.), or a combination thereof. IO device(s) 707 may further include an imaging processing subsystem (e.g., a camera), which may include an optical sensor, such as a charged coupled device (CCD) or a complementary metal-oxide semiconductor (CMOS) optical sensor, utilized to facilitate camera functions, such as recording photographs and video clips. Certain sensors may be coupled to interconnect 710 via a sensor hub (not shown), while other devices such as a keyboard or thermal sensor may be controlled by an embedded controller (not shown), dependent upon the specific configuration or design of system 700.

To provide for persistent storage of information such as data, applications, one or more operating systems and so forth, a mass storage (not shown) may also couple to processor 701. In various embodiments, to enable a thinner and lighter system design as well as to improve system responsiveness, this mass storage may be implemented via a solid state device (SSD). However, in other embodiments, the mass storage may primarily be implemented using a hard disk drive (HDD) with a smaller amount of SSD storage to act as a SSD cache to enable non-volatile storage of context state and other such information during power down events so that a fast power up can occur on re-initiation of system activities. Also a flash device may be coupled to processor 701, e.g., via a serial peripheral interface (SPI). This flash device may provide for non-volatile storage of system software, including a basic input/output software (BIOS) as well as other firmware of the system.

Storage device 708 may include computer-readable storage medium 709 (also known as a machine-readable storage medium or a computer-readable medium) on which is stored one or more sets of instructions or software (e.g., processing module, unit, and/or processing module/unit/logic 728) embodying any one or more of the methodologies or functions described herein. Processing module/unit/logic 728 may represent any of the components described above. Processing module/unit/logic 728 may also reside, completely or at least partially, within memory 703 and/or within processor 701 during execution thereof by system 700, memory 703 and processor 701 also constituting machine-accessible storage media. Processing module/unit/logic 728 may further be transmitted or received over a network via network interface device(s) 705.

Computer-readable storage medium 709 may also be used to store some software functionalities described above persistently. While computer-readable storage medium 709 is shown in an exemplary embodiment to be a single medium, the term “computer-readable storage medium” should be taken to include a single medium or multiple media (e.g., a centralized or distributed database, and/or associated caches and servers) that store the one or more sets of instructions. The terms “computer-readable storage medium” shall also be taken to include any medium that is capable of storing or encoding a set of instructions for execution by the machine and that cause the machine to perform any one or more of the methodologies of embodiments disclosed herein. The term “computer-readable storage medium” shall accordingly be taken to include, but not be limited to, solid-state memories, and optical and magnetic media, or any other non-transitory machine-readable medium.

Processing module/unit/logic 728, components and other features described herein can be implemented as discrete hardware components or integrated in the functionality of hardware components such as ASICS, FPGAs, DSPs or similar devices. In addition, processing module/unit/logic 728 can be implemented as firmware or functional circuitry within hardware devices. Further, processing module/unit/logic 728 can be implemented in any combination hardware devices and software components.

Note that while system 700 is illustrated with various components of a data processing system, it is not intended to represent any particular architecture or manner of interconnecting the components; as such details are not germane to embodiments disclosed herein. It will also be appreciated that network computers, handheld computers, mobile phones, servers, and/or other data processing systems which have fewer components or perhaps more components may also be used with embodiments disclosed herein.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities.

It should be borne in mind, however, that all of these and similar terms are to be associated with the appropriate physical quantities and are merely convenient labels applied to these quantities. Unless specifically stated otherwise as apparent from the above discussion, it is appreciated that throughout the description, discussions utilizing terms such as those set forth in the claims below, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

Embodiments disclosed herein also relate to an apparatus for performing the operations herein. Such a computer program is stored in a non-transitory computer readable medium. A non-transitory machine-readable medium includes any mechanism for storing information in a form readable by a machine (e.g., a computer). For example, a machine-readable (e.g., computer-readable) medium includes a machine (e.g., a computer) readable storage medium (e.g., read only memory (“ROM”), random access memory (“RAM”), magnetic disk storage media, optical storage media, flash memory devices).

The processes or methods depicted in the preceding figures may be performed by processing logic that comprises hardware (e.g. circuitry, dedicated logic, etc.), software (e.g., embodied on a non-transitory computer readable medium), or a combination of both. Although the processes or methods are described above in terms of some sequential operations, it should be appreciated that some of the operations described may be performed in a different order. Moreover, some operations may be performed in parallel rather than sequentially.

Embodiments disclosed herein are not described with reference to any particular programming language. It will be appreciated that a variety of programming languages may be used to implement the teachings of embodiments disclosed herein.

In the foregoing specification, embodiments have been described with reference to specific exemplary embodiments thereof. It will be evident that various modifications may be made thereto without departing from the broader spirit and scope of the embodiments disclosed herein as set forth in the following claims. The specification and drawings are, accordingly, to be regarded in an illustrative sense rather than a restrictive sense.

What is claimed is:

1. A method for managing an inference model, the method comprising:
clustering a data set into first clusters to obtain first cluster assignments for records of the data set;
training a multiheaded inference model using the records and the first cluster assignments;
performing modified split training of the multiheaded inference model to obtain an updated multiheaded inference model;
obtaining an updated data set using the updated multiheaded inference model by removing at least one feature from the data set based on a predictive power level of the multiheaded inference model with respect to the first cluster assignments and a predictive power level for bias features;
clustering the updated data set into second clusters to obtain second cluster assignments for records of the updated data set; and
providing computer implemented services using the second cluster assignments.

2. The method of claim 1, wherein the multiheaded inference model comprises:
a shared body;
a feature head that generates first inferences for the first cluster assignments; and
a bias feature head that generates second inferences for bias features.

3. The method of claim 2, wherein performing the modified split training comprises:
modifying weights of the feature head to increase a predictive power level of the first inferences;
modifying weights of the bias feature head to increase a predictive power level of the second inferences; and
modifying weights of the shared body using the feature head and bias feature head.

4. The method of claim 3, wherein the modified split training is performed using a training data set that associates features of the data set with the first cluster assignments and the bias features.

5. The method of claim 4, wherein obtaining the updated data set comprises:
for each feature of the data set:
identifying a first level of contribution of the feature to the predictive power level of the first inferences;
identifying a second level of contribution of the feature to the predictive power level of the second inferences;
ranking the feature among the features of the of data set based on the first level of contribution and the second level of contribution to identify a worst ranked feature; and
using the worst ranked feature as the at least one feature.

6. The method of claim 5, wherein the features are ranked based on a difference between the first level of contribution and the second level of contribution, and the worst ranked feature having a lowest difference of the differences associated with the features.

7. The method of claim 6, wherein the updated data set comprises less data than the data set.

8. A non-transitory machine-readable medium having instructions stored therein, which when executed by a processor, cause the processor to perform operations for managing an inference model, the operations comprising:
clustering a data set into first clusters to obtain first cluster assignments for records of the data set;
training a multiheaded inference model using the records and the first cluster assignments;
performing modified split training of the multiheaded inference model to obtain an updated multiheaded inference model;
obtaining an updated data set using the updated multiheaded inference model by removing at least one feature from the data set based on a predictive power level of the multiheaded inference model with respect to the first cluster assignments and a predictive power level for bias features;
clustering the updated data set into second clusters to obtain second cluster assignments for records of the updated data set; and
providing computer implemented services using the second cluster assignments.

9. The non-transitory machine-readable medium of claim 8, wherein the multiheaded inference model comprises:
a shared body;
a feature head that generates first inferences for the first cluster assignments; and
a bias feature head that generates second inferences for bias features.

10. The non-transitory machine-readable medium of claim 9, wherein performing the modified split training comprises:
modifying weights of the feature head to increase a predictive power level of the first inferences;
modifying weights of the bias feature head to increase a predictive power level of the second inferences; and
modifying weights of the shared body using the feature head and bias feature head.

11. The non-transitory machine-readable medium of claim 10, wherein the modified split training is performed using a training data set that associates features of the data set with the first cluster assignments and the bias features.

12. The non-transitory machine-readable medium of claim 11, wherein obtaining the updated data set comprises:
for each feature of the data set:
identifying a first level of contribution of the feature to the predictive power level of the first inferences;
identifying a second level of contribution of the feature to the predictive power level of the second inferences;
ranking the feature among the features of the of data set based on the first level of contribution and the second level of contribution to identify a worst ranked feature; and
using the worst ranked feature as the at least one feature.

13. The non-transitory machine-readable medium of claim 12, wherein the features are ranked based on a difference between the first level of contribution and the second level of contribution, and the worst ranked feature having a lowest difference of the differences associated with the features.

14. The non-transitory machine-readable medium of claim 13, wherein the updated data set comprises less data than the data set.

15. A data processing system, comprising:
a processor; and
a memory coupled to the processor to store instructions, which when executed by the processor, cause the processor to perform operations for managing an inference model, the operations comprising:
clustering a data set into first clusters to obtain first cluster assignments for records of the data set;
training a multiheaded inference model using the records and the first cluster assignments;
performing modified split training of the multiheaded inference model to obtain an updated multiheaded inference model;
obtaining an updated data set using the updated multiheaded inference model by removing at least one feature from the data set based on a predictive power level of the multiheaded inference model with respect to the first cluster assignments and a predictive power level for bias features;
clustering the updated data set into second clusters to obtain second cluster assignments for records of the updated data set; and
providing computer implemented services using the second cluster assignments.

16. The data processing system of claim 15, wherein the multiheaded inference model comprises:
a shared body;
a feature head that generates first inferences for the first cluster assignments; and
a bias feature head that generates second inferences for bias features.

17. The data processing system of claim 16, wherein performing the modified split training comprises:
modifying weights of the feature head to increase a predictive power level of the first inferences;
modifying weights of the bias feature head to increase a predictive power level of the second inferences; and
modifying weights of the shared body using the feature head and bias feature head.

18. The data processing system of claim 17, wherein the modified split training is performed using a training data set that associates features of the data set with the first cluster assignments and the bias features.

19. The data processing system of claim 18, wherein obtaining the updated data set comprises:
for each feature of the data set:
identifying a first level of contribution of the feature to the predictive power level of the first inferences;
identifying a second level of contribution of the feature to the predictive power level of the second inferences;
ranking the feature among the features of the of data set based on the first level of contribution and the second level of contribution to identify a worst ranked feature; and
using the worst ranked feature as the at least one feature.

20. The data processing system of claim 19, wherein the features are ranked based on a difference between the first level of contribution and the second level of contribution, and the worst ranked feature having a lowest difference of the differences associated with the features.
